(19) United States
(12) Patent Application Publication
(10) Pub. No.: US 2006/0049766 A1
(43) Pub. Date: Mar. 9, 2006

(54) Magnetron cooling fin

(75) Inventors: Jong Soo Lee, Gyeonggi-do (KR); Yong Soo Lee, Gyeonggi-do (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/211,585

(22) Filed: Aug. 26, 2005

(30) Foreign Application Priority Data
Sep. 3, 2004 (KR) 70379/2004

(51) Int. Cl. H01J 25/50

(52) U.S. Cl. 315/39.51

(57) ABSTRACT

A magnetron cooling fin is disclosed, characterized in that a plurality of turbulence-promoting protrusions are provided on one side of a planar body that has a boss-type through-hole in which an anode is coupled and a plurality of coupling pieces outwardly extending and bent at edges of the planar body, whereby, with inflow air undergoing flow separation at top ends of the turbulence-promoting protrusions and coming again into contact with the planar body, an existing temperature boundary gets thinned and a friction coefficient gets increased, thereby improving a heat transfer rate and an cooling efficiency.

### BACKGROUND OF THE INVENTION

1. Field of the Invention

The present invention relates to a magnetron cooling fin, and more particularly, to a magnetron cooling fin structured to have an enlarged heat transfer area to thereby improve a cooling efficiency.

2. Description of the Related Art

Generally, a magnetron is used as a heat source for heating a target in such a manner that electrons discharged from a cathode upon application of electric power thereto generate radio frequency energy of about 2,450 MHz by means of electric and magnetic fields and the generated energy is then output via an antenna. Such a magnetron comprises an anode unit (10), a cathode unit (20), and a magnetic unit (30), as shown in FIG. 1.

The anode unit (10) comprises an anode cylinder (11), and a plurality of vanes (12) radially formed on an inner surface of the anode cylinder (11). The cathode unit (20) comprises a filament (21), end shields (22) and (23), a center lead (24), and a side lead (25). The filament (21) has a spiral structure formed of alloy materials containing, for example, tungsten (W) and thorium (Th), and is disposed along a central axis of the anode unit (10) to emit thermal electrons. The magnetic unit (30) comprises upper and lower magnetic poles (31. 32) installed at upper and lower ends of the anode cylinder (11) to serve as passages of a magnetic circuit, and magnets (33) provided at a side of each of the upper and lower magnetic poles (31. 32) to form a magnetic field.

An undescribed, reference numeral (41) is indicates a working space for rotary actions of the thermal electrons. Reference numeral (42) is a ceramic stem made of a ceramic insulation material, reference numeral (43) is a choke coil serving as a noise filter circuit, and reference numeral (44) is a feed through capacitor to allow the choke coil (43) to receive an external electric current. Further, reference numerals (45. 46) are respectively an A-seal and an F-seal serving as passages of the magnetic circuit, respectively, reference numeral (47) is an antenna feeder, and reference numeral (48) is an air discharge pipe for discharging air to maintain a vacuum state after assembly of the magnetron is completed. Moreover, reference numeral (100) is a cooling fin installed within a chamber of a yoke (50), which is defined by coupling an upper plate (51) and a lower plate (52) of the yoke.

In the magnetron thus constructed, a magnetic field formed by the magnets (33) forms a magnetic circuit along the upper and lower magnetic poles (31.32), thereby forming a magnetic field in the working space (41) between the vanes (12) and the filament (21). When external electric power is supplied through the feed through condenser (44), the filament (21) emits thermal electrons at a temperature of about 2,000 K. The thermal electrons thus emitted are rotated within the working space (41) by means of the magnetic field of the magnets (33) and a positive voltage of 4.0 to 4.4 kV applied between the filament (21) and the anode unit (10). Electric power is then supplied to the filament (21) via the center lead (24) and the side lead (25) so that an electric field with a frequency of about 2,450 MHz is formed between the vanes (12) and the filament (21). The emitted thermal electrons are forced to undergo cycloid motion within the working space (41) by means of the aforementioned electric and magnetic fields and then converted into high frequency energy which is an electromagnetic energy. The energy is in turn outputted to the outside through the vanes (12) and the antenna feeder (47). In the process of outputting the high frequency energy, the energy is conducted to the cylinder (11) while some of the energy is lost as heat. To effectively dissipate such heat, there is a need of cooling by the cooling fin (100).

Referring to FIG. 2, the cooling fin (100) includes a plurality of fins (121a. 121b. 121c. 121d. 121e. and 121f) bent at both sides of a planar body (110). The planar body (110) has a central through-hole (130) through which a cylindrical anode penetrates and is coupled therein. Reference numerals (151. 152) are respectively a fluid inlet and a fluid outlet. Reference numerals (161. 162. 163. and 164) are respectively first air guides and second air guides.

The plurality of fins (121a. 121b. 121c. 121d. 121e. and 121f) are outwardly formed to enlarge a heat transfer area and simultaneously serve as coupling pieces for connection to the yoke (50).

The cooling fin (100) of the magnetron thus constructed is manufactured with a variety of specifications depending on the output magnitude of the magnetron. However, if a magnetron with the same output needs to have a compact anode structure, there arises a problem of improvement of cooling efficiency being limited, due to a restricted heat transfer area of a cooling fin.

### SUMMARY OF THE INVENTION

The present invention is disclosed to solve the aforementioned problem in the prior art. An object of the present invention is to provide a magnetron cooling fin with an improved structure of an enlarged heat transfer area for facilitating heat transfer, thereby improving a cooling efficiency.

Another object of the present invention is to provide a magnetron cooling fin with an enhanced economical efficiency by modifying a conventional cooling fin of a magnetron to maximize the enlargement of a heat transfer area through a simple and easy manufacturing process, thereby improving cooling performance.

To achieve the objects, a magnetron cooling fin according to the present invention comprises a planar body with a boss-type through-hole through which an anode penetrates to be coupled therein; a plurality of coupling pieces outwardly extending and bent at edges of the planar body; and a plurality of turbulence-promoting protrusions arranged in a predetermined pattern while protruding from at least one side of the planar body.

In the cooling fin of a magnetron thus constructed according to the present invention, preferably, the turbulence-promoting protrusions are provided to protrude in the same direction as that of a peripheral projection of the boss-type through-hole. Preferably, the turbulence-promoting protrusions are arranged to maintain an equidistance therebetween.

According to one aspect of the present invention, preferably, the turbulence-promoting protrusions are formed such that the relationship between a pitch (P) and a height (H) of the turbulence-promoting protrusions satisfies a relation of P/H=1˜10. More preferably, the turbulence-promoting protrusions is formed to satisfy a relation of P/H=6˜8.

According to another aspect of the present invention, the turbulence-promoting protrusions may be formed in a symmetrical pattern at regions of an air inlet and an air outlet with respect to the boss-type through-hole. Alternatively, the turbulence-promoting protrusions may be provided at any one of regions of an air inlet and an air outlet with respect to the boss-type through-hole.

Meanwhile, the turbulence-promoting protrusions may be integrally formed with the planar body, for example, by partially processing the planar body. Alternatively, the turbulence-promoting protrusions may be formed by bonding or coupling separate pieces or members to the planar body. It should be apparent that the turbulence-promoting protrusions may be provided in various configurations such as, in the form of solid or hollow, cylindrical or polygonal columns or protruding pieces formed by cutting some portions of the planar body and erecting the cut portions.

### BRIEF DESCRIPTION OF THE DRAWINGS

The above and other objects, features and advantages of the present invention will become apparent from the following description of a preferred embodiment given in conjunction with the accompanying drawings, in which:

FIG. 1 is a sectional view schematically showing a conventional magnetron;

FIG. 2 is a schematic perspective view showing a portion of a cooling fin of FIG. 1;

FIG. 3 is a schematic perspective view showing a magnetron cooling fin according to the present invention;

FIG. 4 is a schematic perspective view showing a structure of a main portion of a magnetron cooling fin according to the present invention;

FIG. 5 is a conceptual view illustrating a cooling principle of a magnetron cooling fin according to the present invention; and

FIG. 6 is a schematic perspective view showing a state where a plurality of magnetron cooling fins according to the present invention are stacked one above another.

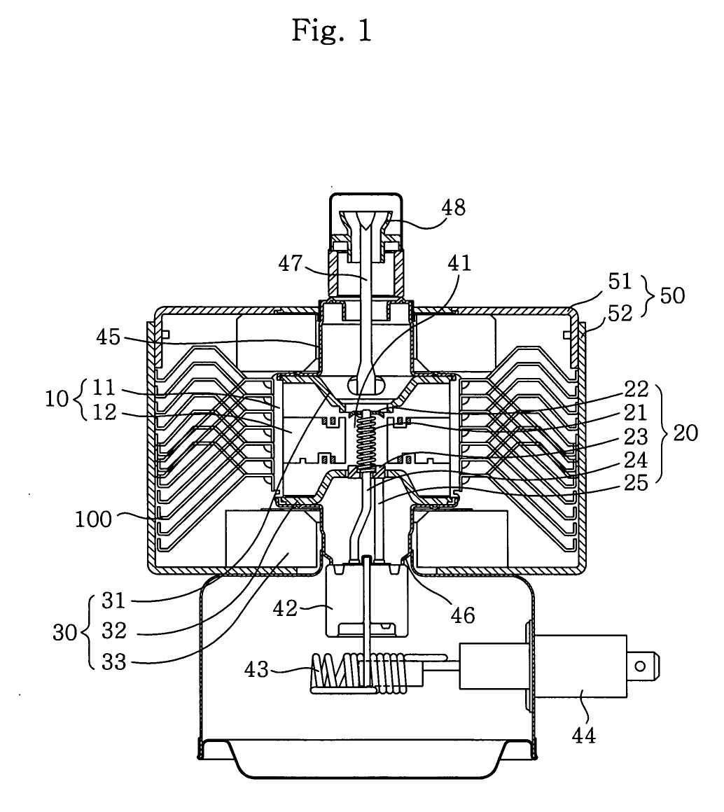

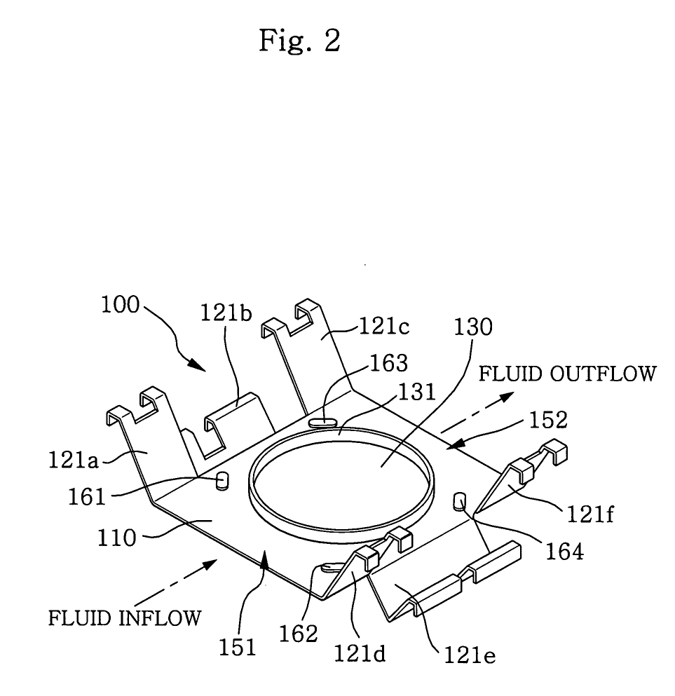

### DETAILED DESCRIPTION OF THE INVENTION

Hereinafter, a magnetron cooling fin according to a preferred embodiment of the invention will be described in detail with reference to the accompanying drawings.

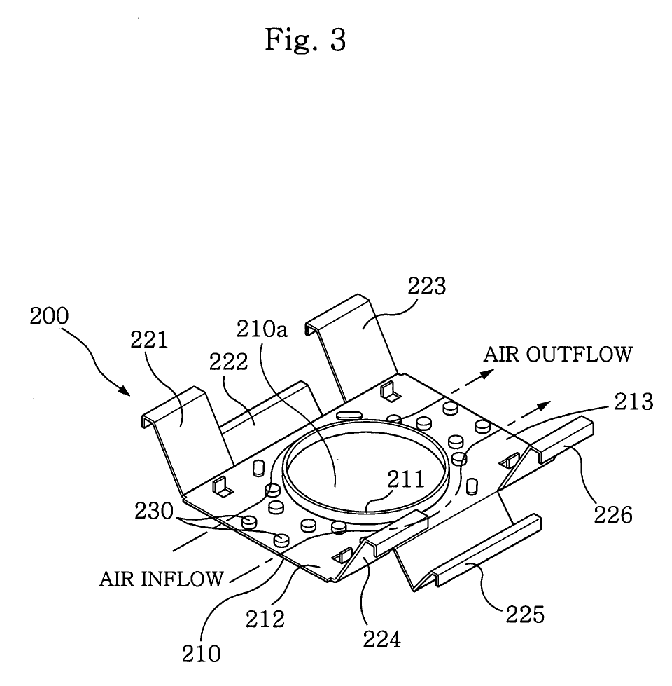

Referring to FIG. 3, a magnetron cooling fin (200) according to the present invention includes a planar body (210) with a boss-type through-hole (210a) through which an anode penetrates to be coupled therein, a plurality of coupling pieces (221. 222. 223. 224. 225. and 226) outwardly extending and bent at edges of the planar body (210), and a plurality of turbulence-promoting protrusions (230) arranged in a predetermined pattern while protruding from one side of the planar body (210).

Preferably, in the magnetron cooling fin thus constructed according to the present invention, the turbulence-promoting protrusions (230) protrude in the same direction as that of a projection (211) protruding from the periphery of the boss-type through-hole (210a).

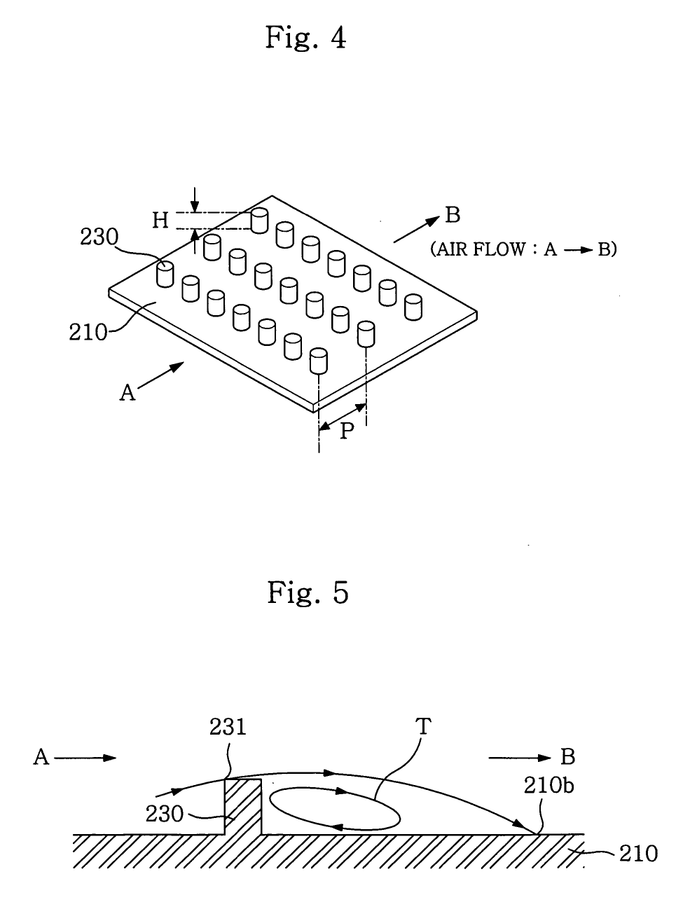

Meanwhile, the turbulence-promoting protrusions (230) are so provided as to satisfy a relation of P/H=1˜10, where P is a pitch between adjacent turbulence-promoting protrusions and H is a height of the turbulence-promoting protrusions, as shown in FIG. 4. Preferably, they are provided to satisfy a relation of P/H=6˜8.

Referring to FIG. 3, preferably the turbulence-promoting protrusions (230) is formed in a symmetrical pattern at regions of an air inlet (212) and an air outlet (213) with respect to the boss-type through-hole (210a).

According to another aspect of the present invention, the turbulence-promoting protrusions (230) may be selectively provided at any one of the regions of the air inlet (212) and the air outlet (212) with respect to the boss-type through-hole (210a).

In the present invention, the turbulence-promoting protrusions (230) may be integrally formed with the planar body (210) by forming hollow bosses, for example, through a punching process or the like at predetermined locations on the planar body (210).

On the other hand, the turbulence-promoting protrusions (230) may be formed by bonding or coupling, for example, separate fin- or boss-type pieces to the planar body (210). The turbulence-promoting protrusions (230) may also be provided in the form of solid or hollow, cylindrical or polygonal columns. Alternatively, the turbulence-promoting protrusions (230) may be provided in various configurations, including protruding pieces formed by cutting some portions of the planar body (210) and erecting the cut portions. However, the present invention is not limited to such specific forms or configurations.

Next, the cooling capability of the magnetic cooling fin (200) according to the present invention will be described with reference to FIG. 5.

When air flows on the planar body (210) form “A” direction to “B” direction, the turbulence-promoting protrusions (230) disturb the air stream to produce a turbulence (T). This is why of the present invention are featured or designated as “turbulence-promoting protrusions (230)”.

Meanwhile, heat transfer between the surfaces of a fluid and a solid depends on the thickness of a temperature boundary layer formed on the surface of the solid. Thus, according to boundary-layer thinning method well known as a heat transfer promoting method, heat transfer can be promoted by thinning the thickness of the temperature boundary layer formed on the surface of the solid. For example, if the flow of a fluid is laminar, the thickness (δₜ) of a temperature boundary layer varies in reverse proportion to the square root of a mainstream velocity (ν) as expressed by the following equation (1). Therefore, in order to reduce the thickness of the boundary layer, it is indispensably required to increase the mainstream velocity or to instantly increase the velocity by disturbing the flow through local formation of a turbulence.

$$h ∝ \frac{1}{{δ}_{t}} ∝ \sqrt{v} \qquad ( 1 )$$

where h is a heat transfer coefficient, δₜ is a thickness of the temperature boundary layer, and ν is a mainstream velocity.

Therefore, in the cooling principle of the turbulence-promoting protrusions (230) that are the features of the cooling fin (200) according to the present invention, as shown in FIG. 5, flow separation of an air stream occurs on top ends of the turbulence-promoting protrusions (230) and the air stream comes again into contact with the planar body (210) at a downstream location (210b) at a distance that is 10 times larger than the height of the turbulence-promoting protrusions (230). At this time, if there is a difference in temperature between the surface of the planar body (210) and the air, the air stream that comes again into contact with the planar body (210) thins an existing surface temperature boundary layer, thereby increasing a heat transfer rate. Accordingly, a high heat transfer rate is achieved at the location (210b) where the air stream comes again into contact with the planar body.

As described earlier, in the magnetron cooling fin (200) of the present invention, the turbulence-promoting protrusions (230) are arranged, each spaced at a predetermined distance apart, on a heat transfer surface of the planar body (210), and a high heat transfer rate is utilized obtained from the locations which exist among adjacent turbulence-promoting protrusions (230) and at which the air stream that has undergone the flow separation comes again into contact with the planar body (210).

Meanwhile, if the turbulence-promoting protrusions (230) are arranged equidistantly on the planar body (210) in the magnetron cooling fin (200) of the present invention, cooling efficiency can be determined depending on the relationship between the pitch (P) and the height (H) of the turbulence-promoting protrusions (230). This will be described below with reference to FIG. 4.

(1) If P/H≈0.5, it is difficult to form a complete eddy between adjacent turbulence-promoting protrusions. Further, there is no location where an air stream comes again into contact with the planar body.

(2) If P/H≈1, one eddy is formed between turbulence-promoting protrusions that are adjacent to each other in an inflow direction of air.

(3) If P/H>1, small eddies are formed at both inside corners of the turbulence-promoting protrusions and have an elliptical shape. There are locations where an air stream comes again into contact with the planar body. As for friction coefficients at the locations, they gradually decrease when the value of P/H is in a range of 1 to 1.3 and are minimized when the value of P/H is 1.3, and then increase again when the value of P/H is 1.3 or higher.

(4) If P/H≈6˜8, flow separation occurs at the top ends of the turbulence-promoting protrusions, and thus, friction coefficients and heat transfer rates at the locations where the air stream comes again into contact with the planar body are maximized.

Based on the foregoing, in the magnetron cooling fin (200) according to the present invention, it is preferred that the ratio P/H of the pitch (P) and the height (H) of the turbulence-promoting protrusions (230) be in a range of 1˜10. Particularly, it is more preferred that the ratio P/H be in a range of 6˜8.

Meanwhile, the turbulence-promoting protrusions (230) are not specifically limited in their configuration. For example, it is most preferred that they be provided in the form of cylindrical columns or cylindrical bosses. It is because a high turbulence velocity and a high heat transfer rate around a cylindrical column are more effective in view of formation of a turbulence, although square columns, embossments, protruding pieces formed by lifting and erecting cut portions of the planar body in addition to the cylindrical columns or cylindrical bosses exhibit substantially same effects in view of the subsequent contact of the turbulence to the planar body. Another reason is that this configuration can have an advantage in view of economical formation by means of punching process using a mold, or the like.

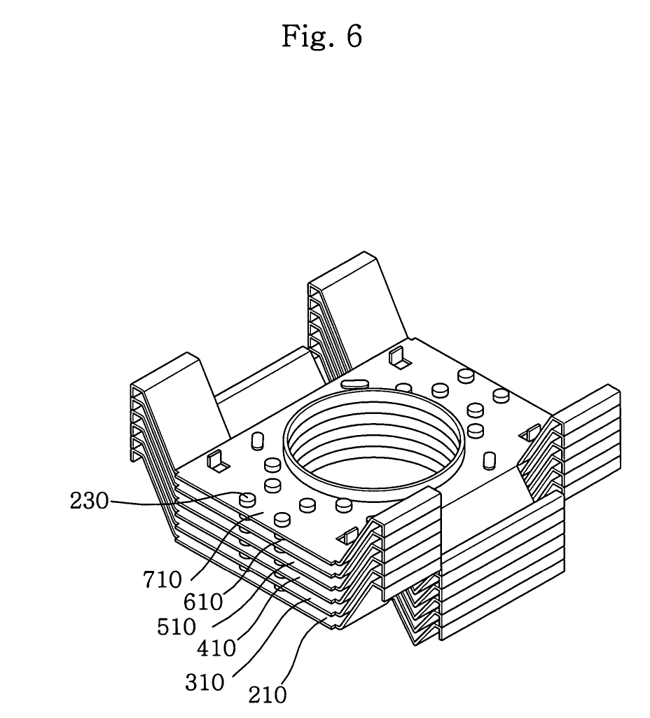

When the magnetron cooling fin (200) of the present invention thus described above is actually installed in a magnetron, a plurality of planar bodies (210. 310. 410. 510. 610. and 710) are installed in a stacked form one above another, as shown in FIG. 6. In order to maximize cooling-promoting effects, the height of the turbulence-promoting protrusions (230) should be designed such that they do not come into contact with a planar body (210) of an adjacent cooling fin (200) in consideration of a gap between planar bodies of adjacent cooling fins.

As apparent from the foregoing, there is an advantage in the magnetron cooling fin thus described according to the present invention in that since the plurality of turbulence-promoting protrusions (230) provided on the planar body (210) generate a turbulence of inflow air and cause flow separation of the air to improve a heat transfer rate, cooling efficiency can be further improved.

There is another advantage in that it is possible to provide a magnetron cooling fin which has enhanced economical efficiency by modifying a conventional magnetron cooling fin to maximally enlarge a heat transfer area through a simple and easy manufacturing process, thereby having more improved cooling performance.

Although the present invention has been described in connection with the preferred embodiment, it will be apparent to those skilled in the art that various modifications and changes can be made thereto without departing from the spirit and scope of the present invention, and such modifications and changes fall within the scope of the invention defined by the appended claims.

What is claimed is:

1. A magnetron cooling fin, comprising:
a planar body with a boss-type through-hole through which an anode penetrates to be coupled therein;
a plurality of coupling pieces outwardly extending and bent at edges of the planar body; and
a plurality of turbulence-promoting protrusions arranged in a predetermined pattern while protruding from at least one side of the planar body.

2. The cooling fin as claimed in claim 1, wherein the turbulence-promoting protrusions are provided to protrude in the same direction as that of a peripheral projection of the boss-type through-hole.

3. The cooling fin as claimed in claim 1, wherein the turbulence-promoting protrusions are arranged to maintain an equidistance therebetween.

4. The cooling fin as claimed in claim 1, wherein the turbulence-promoting protrusions are formed such that the relationship between a pitch (P) and a height (H) of the turbulence-promoting protrusions satisfies a relation of P/H=1˜10.

5. The cooling fin as claimed in claim 1, wherein the turbulence-promoting protrusions are formed in a symmetrical pattern in regions of an air inlet and an air outlet with respect to the boss-type through-hole.

6. The cooling fin as claimed in claim 1, wherein the turbulence-promoting protrusions are selectively provided at any one of regions of an air inlet and an air outlet with respect to the boss-type through-hole.

7. The cooling fin as claimed in claim 1, wherein the turbulence-promoting protrusions are integrally formed with the planar body by partially processing the planar body.
